(19) United States
(12) Patent Application Publication
(10) Pub. No.: US 2010/0041417 A1
(43) Pub. Date: Feb. 18, 2010

(54) System for determining network structure and positions of mobile devices in a wireless communication network

(76) Inventors: Hans Lind, Savedalen (SE); Mattias Jonsson, Molndal (SE)

Correspondence Address: ERICSSON INC., 6300 LEGACY DRIVE, M/S EVR 1-C-11, PLANO, TX, 75024, US

(21) Appl. No.: 12/521,286

(22) PCT Filed: Dec. 28, 2006
(86) PCT No.: PCT/SE2006/001513

§ 371 Date: Oct. 12, 2009

(51) Int. Cl. H04W 64/00

(52) U.S. Cl. 455/456.1

(57) ABSTRACT

The present invention relates to a solution for determining the location of a mobile communication device in a wireless communication network and for determining a network structure of the wireless communication network using a system of plurality of receivers acquiring radio signals from units in the communication network within a geographical area and triangulating the location of the units. The device may be arranged to trigger a re-establishment of connections between units in order to force communication control signal traffic which can be monitored.

### TECHNICAL FIELD

The present invention relates to a system, devices and method for determining a network structure and position of a mobile station within or outside an area of coverage of a wireless communication network.

### BACKGROUND OF THE INVENTION

With the advent of wireless telecommunication equipment new possibilities of communication use has been developed and used by both good parties and parties that use these possibilities for illegal purposes. For instance the modern telecommunication technology may be used for crime, threats or terrorism. In these situations it is of interest to build a picture of the static and dynamic network structure in order to assess the situation and possibly control communication links, e.g. stop certain mobile phones or keep track of certain mobile phones both logical and physical (geographical) connections. Also, it would be of interest to know the different base stations that is present in the area of interest and if possible their locations. Operators today can provide information about singular mobile phones within a cell connected to a base station and even information about the position of a certain mobile phone using triangulation of signals from the mobile phone to several base stations within the operator's network.

Furthermore, this type of information is available from the operator or operators of the networks and this may hamper the information exchange in some situations since it may be difficult to obtain a rapid picture of the current network structure or some operators may be reluctant to provide such information. In some cases it will be difficult since connections to all operators operating within a certain area need to open and information readily available. This is not the case if there is an emergency situation where the infrastructure has been disconnected or disabled in some way, for instance in a disaster situation such as after an earthquake, acts of terrorism or war, explosions and so on. In these types of situations time it is very critical and even if the infrastructure is operating in a sufficient manner, rescue workers may not have time to rely on the operators to supply essential information about all mobile stations in an area.

### SUMMARY OF THE INVENTION

It is therefore the object of the present invention to provide a solution for determining the position of individual mobile stations and/or network structure within a geographical area that is independent of communication with any operators and/or infrastructure devices. This is provided for in number of aspects, wherein a first is a system for determining the position of mobile stations, the identity of these, the position of bases stations, and the pairing of mobile stations and base stations to determine physical connections.

This system for finding the structure and/or geographical position of communication units in at least one wireless communication network, may comprise:
at least one receiver for acquiring radio signals from the wireless communication units; and
a controller for collecting information related to acquired signals; characterized in that the at least one receiver is arranged to acquire radio traffic information within the at least one communication network and to send the acquired radio traffic information to the controller for further analysis in order to determine the network structure and/or geographical position of wireless communication units.

The may further be arranged to pair mobile stations in communication with each other or with gateway units within the mobile communication network.

The system may further comprise a plurality of receivers in order to acquire signals for triangulation analysis.

The system may further comprise a transmitter arranged to send a signal triggering a re-establishment of connections between units in the wireless communication network.

The transmitter may be arranged to operate independently of any network based permissions between communication units.

The receiver may be arranged to operate stand alone from any infrastructure communications network and is arranged to participate in a local communications network formed by the at least one receiver and controller.

The receiver may be arranged to acquire signals independent of service agreements of the communication units.

Another aspect of the present invention, a detection device for finding the physical network structure of a wireless communication network is provided, comprising a receiver for acquiring radio signals from communication units within the network, a communication interface towards at least one other detection device for receiving information about radio signal acquired by the at least one other detection device, and a processor arranged for executing triangulation processing of data based on acquired signals.

The device may further comprise a transmitter arranged to send a signal triggering a re-establishment of connections between units in the wireless communication network.

The signal causing re-establishment may comprise at least one of a jamming signal and a protocol command signal. The processor may further be arranged to analyze communication traffic between units in communication between each other within the network. The device may further comprise means for acting as a base station for the mobile units. The device may further comprise a direction sensitive antenna.

Yet another aspect of the present invention, a method for finding the network structure of or location of units in a wireless communication network is provided, comprising the steps of:
arranging a plurality of receivers arranged to listen and identify radio traffic in the wireless communication network;
obtaining communication traffic using the plurality of receivers;
acquiring obtained traffic in a control unit;
analysing the communication traffic in the control unit;
triangulating locations for the units within the network.

The method may further comprise a step of forcing re-establishment of connections between the mobile stations and the communication network prior to acquiring communication traffic using the plurality of receivers.

The method may further comprise the step of determining mutual connections between units in the network. The method may further comprise the step of determining locations as coordinates in a map and in height.

Still another aspect of the present invention, a communication unit for operation in a wireless communication network is provided, comprising at least one communication interface and a processing unit arranged to transmit information stored in a memory about the communication unit to at least one stand alone position detection receiver.

The information stored about the communication unit may comprise at least one of ID of communication unit, ID of user, health information of the user, equipment related to the communication unit or the user, and status information of the user.

The invention provides several advantages when it concerns finding people in a geographical area since it is possible to detect people with mobile stations (e.g. cell phones) and it is therefore not necessary to equip them with specialized transponders. It is possible to determine the network structure of a communications network and provide intelligence about this network. This can be provided without the infrastructure of the network being operational or even aware of a search or network detection being conducted. It can also be done at low cost and using limited resources available using stand alone equipment.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates a system according to the present invention in an example of a network;

FIG. 2 illustrates a detection device according to the present invention;

FIG. 3 illustrates a method according to the present invention;

FIG. 4 illustrates a second embodiment of the present invention; and

FIG. 5 illustrates a communication unit according to the present invention.

### DETAILED DESCRIPTION OF PREFERRED EMBODIMENTS

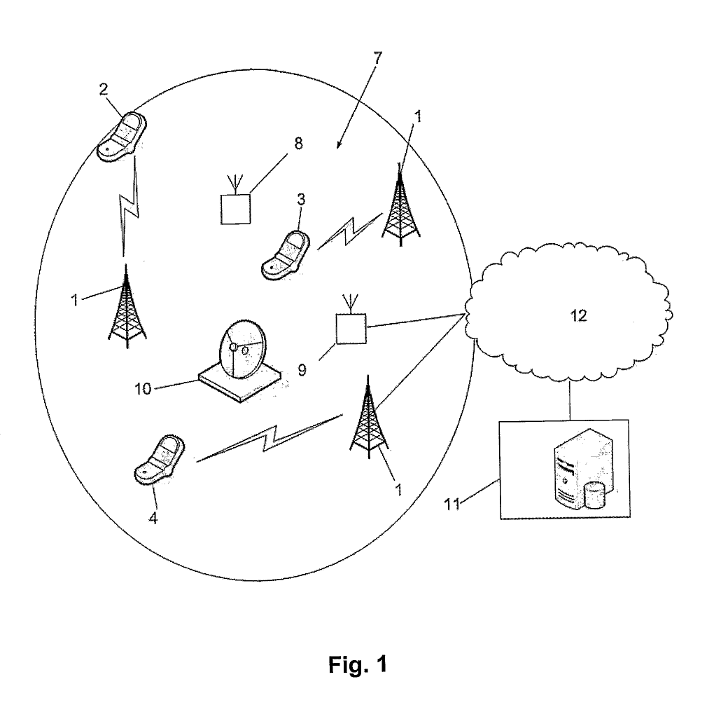

In FIG. 1 reference numeral 1 generally indicate a base station for a wireless communication network cell and 2-4 mobile stations located within the an area 7 wherein it is of interest to detect mobile stations and base stations 1. Communication receivers 8-10 are shown in FIG. 1 and used for receiving signals from the mobile stations and base stations within the area that is under surveillance. The receivers 8-10 are controlled by a control unit 11 located in the network as an independent unit, as part of one communication receiver 8-10, or independently on an external network 12 connected to the receivers 8-10. The connection between the receivers 8-10 on one hand and the external network 12 on the other hand can be maintained either through a wireless communication link using one of the base stations 1 under surveillance or some other wireless communication gateway (e.g. another base station not under surveillance, a mobile communication satellite), or using a stand alone wireless interface used only between the receivers (using either a standard or proprietary wireless protocol), or the connection may also be of a wired type. The receiver can together form a local communication network together with the controller 11. In case of the controller located as part of one of the communication receivers the communication between the communication receivers may be any suitable radio interface with sufficient range and communication bandwidth. The present invention may operate as a stand alone system or device disconnected to any external network for providing redundancy and independency from possible bottle necks. The communication receiver may be equipped with a directional antenna to facilitate detection of direction of mobile station and base stations within detection range of the receiver. This is indicated in FIG. 1 for the receiver referenced as 10. It should be understood that none, all or only part of the receivers used together may be equipped with a directional antenna (i.e. an antenna with a directional sensitivity being able to determine the direction received signals comes from). The receiver will operate independently on any service agreements existing between communication units; i.e. for instance operator/service provider connection of mobile stations 2, 3, 4, e.g. normally a mobile station is logically and business wise connected to a service provider and roaming to other service providers within a country of origin is not permitted whereas the present invention will not depend on any such service agreements but is arranged to receive signals from mobile stations belonging to any service provider. The receiver may be arranged to change the communication protocol to adapt to network under surveillance or in order to communicate with mobile stations using any suitable radio communication interface.

The present invention is operating in a mobile communication network structure, for instance a GSM, GPRS, UMTS, CDMA2000, Tetra, APCO P25, EDACS, iDEN or similar networks or it could also be other wireless networks for instance built up by Wireless Local Area Network (WLAN) solutions using for instance 802.11, 802.15, or 802.16 series of wireless communication protocols. The invention is applicable to any suitable standard or non standard wireless communication method that can be detected. There is no need for any special adaptation of any infrastructure or mobile devices present in the network under scrutiny since the system may operate stand alone without any special cooperation from these parts of the network. The system according to the present invention passively listens to the radio traffic within the network(s) to determine the structure of the network and/or the location of the different devices present within listening range of the receiver. However, in some cases in order to determine the location of mobile stations in the network, the communication may be required to be active, i.e. the mobile stations communicate directly with at least one of the communication receivers, or semi-active, i.e. the communication receivers ensures in some way that all mobile stations re-establish contact with infrastructure units in the network, e.g. through a jamming signal detaching mobile stations from the communications network, or through a reset procedure making sure initial communication to attach the mobile station to the communication network takes place and thus can be traced.

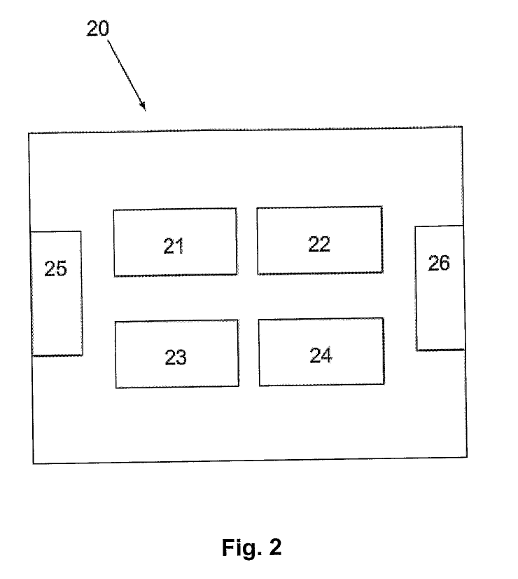

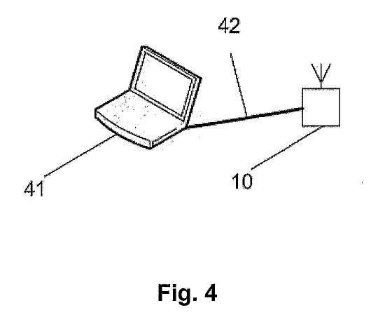

FIG. 2 illustrates a receiver according to the present invention. The receiver 20 comprises at least one processing device 21 for running program code for controlling the measurement and communicating with the central unit. The receiver may further comprise at least one storage unit 22, advantageously of non-volatile type, such as Flash or hard disk memory; the receiver may also comprise a volatile memory (e.g. RAM of any suitable type) 23 for temporary storage of data, program code and instruction sets. The receiver also has one or several interfaces 24 for receiving radio signals from the network under surveillance; the interface 24 may also be used for transmittal of radio signals. In some embodiments the control unit and the receiver is located within the same hardware unit and in this case the processing unit is also adapted to handle program code for communicating control signals and collected data with the other receivers in the system. Furthermore, the control unit may be adapted to interface with the user through different types of interface solutions 25, such as a computer like keyboard, interface devices (e.g. buttons, dials, switches and similar), or through a communication interface 26 where the user if the system is operating software on a laptop or other computing device in turn controlling the control unit. FIG. 4 illustrates a system where a receiver 10 is controlled by a laptop 41 through a communication interface 42 (e.g. USB Universal Serial Bus), RS232, RS485, RS422, printer port, or Firewire port). Also, the stand alone receivers may be equipped with similar interface solutions. It should also be understood that the communication interface 42 may be of any suitable kind and is not limited to the above mentioned, for example it may also be other serial interfaces such as CAN bus, Intellibus, SPI bus, FlexRay, and I2C bus. The communication interface 42 may also be of a wireless type such as using Bluetooth or WLAN. The receiver can be designed into any suitable type of equipment such as but not limited to a handheld device, a standalone weather protected device, or a vehicle mounted device.

The user may control a number of different parameters of the receiver and/or control unit, for instance frequency ranges to scan in, communication protocols to scan, what type of collected data to read and/or store, geographical range, amplitudes to scan, number of operators and/or specific operator(s), number of mobile stations to operate with, active/passive mode of the device, and so on. The receiver may also be arranged to automatically choose at least some of the parameters depending on the settings entered by the user, for instance the receiver may be arranged to determine which communication protocols that can be detected and the user chooses one or several of these and the receiver may then choose appropriate configurations and parameters according to this choice.

The receiver may be arranged with a transmitter for transmitting control signals in the wireless communication network wherein it is operating or listening to traffic in. This may for instance be of use if the receiver would need to trigger mobile units that are connected to the infrastructure network of interest but which are not sending any messages on established channels. The receiver may then transmit a jamming or disturbance signal of any suitable kind in the network in order to enforce updates from all connected mobile stations, this may be done for instance by transmitting a signal strong enough to block control signals between the infrastructure and the mobile stations which will enforce them to re-establish contact with each other. The receiver may also force a disconnection of the mobile stations through the jamming or signal or transmittal of disconnection control command and then act as a base station to which the mobile stations attach to. This last procedure is especially useful in a scenario where the infrastructure network has been disrupted (e.g. in a disaster area).

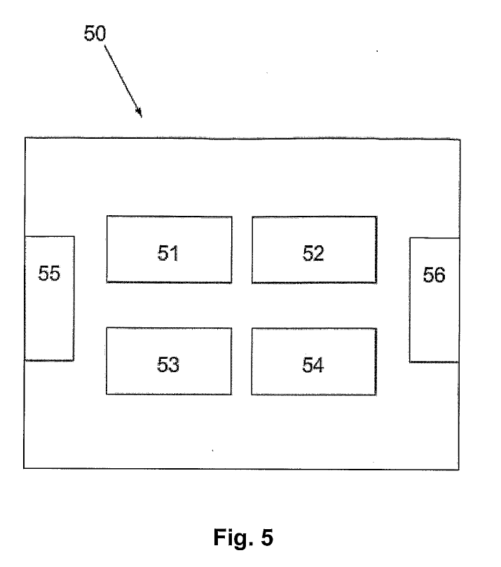

The receiver may also be arranged to receive an identification signal from each unit in the network, for instance the IMSI of each mobile station. Likewise, the units in the network is often arranged to transmit their unique identification (ID) or they may optionally be arranged with means for transmitting a unique ID. The mobile stations may also be arranged to transmit other useful information apart from the unique ID, this may for instance be information about the user such as medical information that might be useful to rescue workers, e.g. diabetes or heart condition that require special medical attention. This can also be used in a military application of the invention, where each soldier, transportation device or even individual equipment can be found using the invention and extra information can be extracted about the person or device holding a mobile station with such information available. Other useful information may be, but not limited to, installed equipment on a device or person (e.g. soldier or rescue worker), equipment performance, person status (e.g. working hours, rank, position, or skills), or anything else that could be of interest depending on situation (rescue team, military application). In this case the communication units in the network need to be included with a solution for distributing this type of information. Such a communication unit (50) is illustrated schematically in FIG. 5.

FIG. 5 illustrates in a schematic block diagram a communication unit (mobile station, base station, access gateway) 50 according to the present invention, wherein a processing unit 51 handles user commands, communication data and communication control information. The communication unit 50 may further comprise a volatile (e.g. RAM) 52 and/or non volatile memory (e.g. a hard disk or flash disk) 53, and a user interface unit 54. The communication unit 50 may further comprise at least one communication unit 55 and may further comprise a second communication unit 56, each with a respective connecting interface. All units in the communication unit can communicate with each other directly or indirectly through the processing unit 51. It should be noted that the communication units may be implemented into the same hardware unit, for instance dual access technologies may be implemented into the same microelectronic device or it may be implemented into a device handling a soft radio application (i.e. where the radio coding is controlled to a large extent in software).

With a unique ID transmitted and received it is possible to exclude mobile stations from a search list, for instance if a person is found in a rescue operation but the mobile station is still transmitting from a collapsed building, the rescue workers may decide to not search in that location primarily but concentrate first on locations where mobile stations is located using the solution according to the present invention and where the mobile stations are identified and connected to persons still missing. This may facilitate the rescue workers operation by helping them to prioritize more easily.

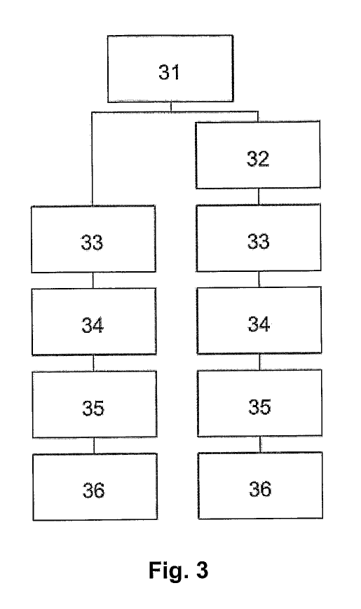

FIG. 3 illustrates a method according to the present invention. Depending on measurement setup the user or program code in the central unit may decide on frequencies and communication protocols that are of interest and this information is sent to the receivers. In some cases the receivers need to jam or disturb the radio connections between the mobile stations and the infrastructure in order to enforce a re-establishment between the mobile stations and the infrastructure. The receivers scan and listen at the decided communication frequencies and protocols. When a sufficient amount of data has been collected or at timely intervals (e.g. streaming as they are collected, once every 10^{th} second, every minute or any other time range suitable with respect to information collection and/or storage capacity), the collected data is sent to the central unit for further analysis, correlation, calculations and pairing. Finally the result is displayed for the user of the system, for instance graphically on a map or as text based information. Different types of analysis may be provided in the system, for instance correlation between mobile units and base stations, calculating geographical locations using triangulation data, pairing of mobile user, i.e. who is communicating with whom, or which mobile stations that are communicating with what base stations in the area. Other information may be of interest such as statistical information about the network topology, capacity in each cell for separate operators and so on.

The steps of the method can be summarized as follows:

31. A user determines what type of detection is to be conducted and the parameters of interest for this type of detection;
32. Optionally, the system can force a re-establishment of the units in the network under surveillance;
33. Acquiring radio signals from the units in the network;
34. Sending the acquired radio signals to a controller;
35. Analysing the radio signals;
36. Triangulating locations of the units in the network.

In calculating the geographical location of mobile stations and base stations it is possible to determine 2 dimensional locations (for instance as map coordinates) as well as 3 dimensional locations (including height information) using a proper placement of the receivers and an appropriate number of receivers. The receivers are advantageously located in different locations in order to provide an efficient triangulation and in order to obtain height information they are also advantageously located at different heights (as compared to a reference plane, e.g. the sea level). For determining height information more than three receivers may advantageously be used. The receivers may use GPS (Global Positioning System) data or similar absolute positioning information to obtain more accurate data and/or to be independent on local positioning services (such as for instance mobile phone base stations). It is advantageous to be independent on local services since then the solution may be operated in areas where these have been disabled or where it is of interest to operate redundantly.

Collected information may be used for instance for competitor analysis. However, another usage for the invention may be for governmental purposes for instance for law enforcement agencies to monitor mobile communication networks for illegal activities such as acts of terrorism, bank robberies, riots and so on. The law enforcement agency may then be able to pair users, through legal intercept or other means, with each other within certain areas of interest to closely follow potential user with criminal intent. It is also possible to in an emergency situation provide information about location of mobile stations (end thus potentially the users of these).

The collected data information may also be paired with information from Call Data Records (CDR) for various purposes such as capacity and billing purposes but also for user behaviour analysis.

The solution according to the present invention may be utilized in a number of interesting areas of interest, such as mentioned for commercial activities or rescue activities. However, the invention and the embodiments of the invention are not restricted to these application areas, but can also be utilized in military application areas: for instance for determining the network structure of an internal communication network between units within a battle field or for acquiring the structure of the opponent in a given location. It also applicable to determine the location of individual soldiers in a given area of coverage if the soldiers have individual communication devices which transmit signals which the receivers according to the present invention can receive.

The invention can be used in at least two different modes:
1. location of mobile stations/transponders in within listening range of the receivers; and
2. network structure detection.

These two different types of modes allows for different usage: the first is suitable for finding mobile stations in an area where network coverage is bad or non-existing, for instance in a disaster area or in locations where mobile network coverage normally is of low quality (e.g. in a forest, for instance when locating a person that has become lost in the forest) whereas the second mode is more suitable for intelligence work of network structure and competitor analysis. It should be noted that in the first mode the mobile stations function as a transponder, not that different from for instance avalanche transponders.

It should also be understood that the two modes can of course operate in the other application as well, depending on what is required and what type of information is wanted.

With the term wireless communication unit is meant a unit that communicates using a wireless interface (e.g. radio or optical based); however, the unit may also at the same time be connected to a wired communication network and/or a power supply. For instance, a base station may communicate with mobile stations using a radio interface while at the same time be connected to a fixed network with a wired connection.

It should be noted that the word “comprising” does not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means”, “devices”, and “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A system for finding a the structure and geographical position of communication units in a wireless communication network, comprising
a receiver for acquiring radio signals from the wireless communication units; and
a controller for collecting information related to acquired signals;
the receiver being arranged to acquire radio traffic information within the communication network and to send the acquired radio traffic information to the controller for further analysis in order to determine the network structure and geographical position of communication units.

2. The system according to claim 1, wherein the system is further arranged to pair mobile stations in communication with each other or with gateway units within the mobile communication network.

3. The system according to claim 1, wherein the system comprises a plurality of receivers in order to acquire signals for triangulation analysis.

4. The system according to claim 1, further comprising a transmitter arranged to send a signal triggering a re-establishment of connections between units in the wireless communication network.

5. The system according to claim 4, wherein the transmitter is arranged to operate independently of any network based permissions between communication units.

6. The system according to claim 1, wherein the receiver is arranged to operate stand alone from any infrastructure communications network and is arranged to participate in a local communications network formed by the receiver and the controller.

7. The system according to claim 1, wherein the receiver is arranged to acquire signals independent of service agreements of the communication units.

8. A detection device for finding a physical network structure of a wireless communication network, the detection device comprising
a receiver for acquiring radio signals from communication units within the network, a communication interface towards another detection device for receiving information about radio signal acquired by the another detection device, and
a processor arranged for executing triangulation processing of data based on acquired signals.

9. The device according to claim 8, further comprising a transmitter arranged to send a signal triggering a re-establishment of connections between units in the wireless communication network.

10. The device according to claim 9, wherein the signal causing re-establishment comprises a jamming signal and a protocol command signal.

11. The device according to claim 8, wherein the processor is further arranged to analyze communication traffic between units in communication between each other within the network.

12. The device according to claim 8, further comprising a radio interface for acting as a base station for the mobile units.

13. The device according to claim 8, further comprising a direction sensitive antenna.

14. A method for finding the network structure of, or location of units in a wireless communication network, the method comprising the steps of:
arranging a plurality of receivers for listening and identifying radio traffic in the wireless communication network;
obtaining communication traffic using the plurality of receivers;
acquiring obtained communication traffic in a control unit;
analysing the communication traffic in the control unit; and
triangulating locations for the units within the network.

15. The method according to claim 14, further comprising a step of forcing re-establishment of connections between the mobile stations and the communication network prior to acquiring communication traffic using the plurality of receivers.

16. The method according to claim 14, further comprising the step of determining mutual connections between units in the network.

17. The method according to claim 14, further comprising the step of determining locations as coordinates in a map as well as height information.

18. A communication unit for operation in a wireless communication network, comprising
a communication interface and
a processing unit arranged to transmit information stored in a memory about the communication unit to at least one stand alone position detection receiver.

19. The communication unit according to claim 18, wherein the information stored about the communication unit comprises at least one of ID of communication unit, ID of user, health information of the user, equipment related to the communication unit or the user, and status information of the user.
